(19) United States
(12) Patent Application Publication
(10) Pub. No.: US 2015/0116384 A1
(43) Pub. Date: Apr. 30, 2015

(54) DISPLAY DEVICE AND COMPENSATION METHOD FOR THE SAME

(71) Applicant: Samsung Display Co., Ltd., Yongin-city (KR)

(72) Inventors: Jeong Kyoo Kim, Suwon-si (KR); Kyung Man Kim, Suwon-si (KR); In Bok Song, Hwaseong-si (KR); Choong Sun Shin, Yongin-si (KR)

(73) Assignee: Samsung Display Co., Ltd., Yongin-city (KR)

(21) Appl. No.: 14/265,089

(22) Filed: Apr. 29, 2014

(30) Foreign Application Priority Data
Oct. 28, 2013 (KR) 10-2013-0128714

(51) Int. Cl. G09G 3/20; G09G 3/32; G09G 3/36

(52) U.S. Cl. CPC G09G 3/20; G09G 3/36; G09G 3/3208; G09G 2320/0233; G09G 2320/0626
USPC 345/694; 345/92; 345/77

(57) ABSTRACT

A display device and an optical compensation method for the same are disclosed. In one aspect, the method includes displaying a test image on the display panel, wherein the display panel comprises first, second, and third areas. The method also includes photographing the first and second areas together to generate first photographed data, photographing the second and third areas together to generate second photographed data, and extracting luminance data from each of the first and second photographed data. The method further includes respectively applying different weights to the luminance data of the second area extracted from each of the first and second photographed data to generate compensated luminance data, and generating a compensation parameter for each pixel based at least in part on the compensated luminance data.

### CROSS-REFERENCE TO RELATED APPLICATIONS

This application claims priority to and the benefit of Korean Patent Application No. 10-2013-0128714 filed in the Korean Intellectual Property Office on Oct. 28, 2013, the entire contents of which are incorporated herein by reference.

### BACKGROUND

1. Field

The described technology generally relates to a display device and an optical compensation method for the same.

2. Description of the Related Technology

Recently, flat panel displays such as liquid crystal displays (LCDs), organic light-emitting diode (OLED) displays, electrophoretic displays (EPD), and the like have been used as commercial products.

Flat panel displays include a plurality of pixels arranged in a matrix and a display panel including scan lines and data lines connected to the pixels. Images are displayed on flat panel displays by selectively applying a data signal to each pixel using the scan and data lines.

Flat panel displays can be categorized according to their driving method into passive matrix and active matrix displays. Active matrix displays use thin film transistors (TFTs) as active elements and have favorable resolution, contrast, operational speeds, and the like, and thus are very popular.

### SUMMARY OF CERTAIN INVENTIVE ASPECTS

One aspect is a display device having an improved uniformity in luminance.

Another aspect is a display device having a compensated luminance deviation for each pixel.

Another aspect is an optical compensation method of a display device including displaying a test image, dividing a screen into a first area, a second area, and a third area and acquiring first photographed data and second photographed data by respectively photographing an area including the first area and the second area and an area including the second area and the third area, extracting luminance data of the first and second areas from the first photographed data and extracting luminance data from the second and third luminance data from the second photographed data, with respect to luminance data of the second area, extracted in an overlapping manner, calculating compensated luminance data of the second area by respectively applying different weights to the luminance data of the second area, extracted from the first photographed data, and the luminance data of the second area, extracted from the second photographed data, generating luminance data of each pixel from the luminance data of the first area, the compensated luminance data of the second area, and the luminance data of the third area, generating a compensation parameter for each pixel from the pixel-specific luminance data, storing the compensation parameter of each pixel, and compensating pixel-specific luminance using the compensation parameter of each pixel.

The applying the different weights may include applying a first weight that gradually decreases toward the third area with respect to the luminance data of the second area, extracted from the first photographed data, and applying a second weight that gradually increases toward the third area with respect to the luminance data of the second area, extracted from the second photographed data.

The first weight may be smaller than 1 and greater than 0 and the sum of the first weight and the second weight may be 1.

The applying the different weights may include dividing the second area into a plurality of areas and applying a weight that gradually increases to each area, and the calculating the compensated luminance data of the second area includes summing luminance data applied with weights.

The dividing the second area to the plurality of areas may include dividing the second area into first to ninth sub-areas and the first weight may be 0.9 in the first sub-area and gradually decreases by 0.1 for each sub-area toward the ninth sub-area.

The second area may include about 100 to about 300 pixel arrays.

The generating the compensation parameter of each pixel may include calculating data related to a TFT threshold voltage from the pixel-specific luminance data and generating a parameter for compensating a difference from a reference luminance using the calculated data.

The storing of the compensation parameter of each pixel may include storing the compensation parameter of each pixel in a non-volatile memory.

The compensating of luminance of each pixel may include generating luminance-compensated image data by compensating an input image signal.

Another aspect is a display device including a display panel including a plurality of pixels, a signal controller generating image data by receiving an image signal and generating a signal that controls operation of the display panel, and a storage unit storing a compensation parameter used for compensation of luminance of each pixel. The compensation parameter is generated from the luminance data of each pixel and the luminance data of each pixel is generated from luminance data of a first area, compensated luminance data of a second area, and luminance data of a third area which are obtained by: displaying a test image in the display panel, dividing a screen into the first area, the second area, and the third area, and acquiring first photographed data and second photographed data by photographing an area including the first area and the second area and an area including the second area and the third area, extracting the luminance data of the first and second areas from the first photographed data and extracting the luminance data of the second and third areas from the second photographed data, and with respect to the luminance data of the second area, extracted in an overlapping manner, calculating the compensated luminance data of the second area by applying different weights to the luminance data of the second area, extracted from the first photographed data, and the luminance data of the second area, extracted from the second photographed data.

When the different weights are applied, a first weight that gradually decreases toward the third area may be applied to the luminance data of the second area, extracted from the first photographed data and a second weight that gradually increases toward the third area may be applied to the luminance data of the second area, extracted from the second photographed data.

The first weight may be smaller than 1 and greater than 0 and the sum of the first weight and the second weight may be 1.

When the different weights are applied, the second area may be divided into a plurality of areas and then gradually increasing or decreasing weights may be applied to the respective areas, and the calculation of the compensated luminance data of the second area may include summing of the luminance data applied with the weights.

When the second area is divided into the plurality of areas, the second area may be divided into first to ninth sub-areas, and the first weight may be 0.9 in the first sub-area and may gradually decreases by 0.1 for each sub-area toward the ninth sub-area.

The second area may include about 100 to about 300 pixel arrays.

The compensation parameter may be a parameter compensating a difference with reference luminance.

The storage unit may include an EEPROM memory.

The display device may further include an operation unit that generates the compensation parameter from the luminance data of each pixel.

Another aspect is an optical compensator for a display device including a display panel including first, second, and third areas, where the first and second areas have been photographed together as first photographed data and the second and third areas have been photographed together as second photographed data, and a plurality of pixels, the optical compensator including an optical processor configured to extract luminance data from each of the first and second photographed data, apply a boundary elimination algorithm to the luminance data of the second area extracted from each of the first and second photographed data to generate compensated luminance data, and generate a compensation parameter for each pixel of the display device based at least in part on the luminance data and the compensated luminance data.

The optical processor is further configured to respectively apply different weights to the luminance data of the second area extracted from each of the first and second photographed data to generate the compensated luminance data. The optical compensator further includes a memory configured to store the compensation parameter for each pixel. The optical processor is further configured to divide the second area into a plurality of sub-areas and apply a different weight to the luminance data of each sub-area extracted from the first and second photographed data to generate the compensated luminance data.

According to at least one embodiment, luminance non-uniformity in a display device can be improved. Particularly, when a plurality of photographs are required to acquire luminance data with respect to all pixels of a high-resolution display device, the luminance data is sufficiently compensated to minimize or ignore a deviation at the periphery of a boundary of the acquired photographed data to thereby enable accurate optical compensation.

### BRIEF DESCRIPTION OF THE DRAWINGS

FIG. 1 is a layout view of a display device according to an exemplary embodiment.

FIG. 2 is an exemplary circuit diagram of one pixel in the display device of FIG. 1.

FIG. 3 is a flowchart provided for the description of a schematic process of an optical compensation method of the display device according to an exemplary embodiment.

FIG. 4 is a flowchart provided for the description of a process added in a plurality of photographing processes in the optical compensation method of FIG. 3.

FIG. 5 is a schematic diagram illustrating an example of dividing one screen into a left area and a right area and extracting luminance data in an overlapping manner in two photographing steps.

FIG. 6 is a table illustrating a boundary compensation algorithm according to an exemplary embodiment.

FIG. 7 shows subdivided areas of an overlap area of FIG. 5.

FIG. 8 is a table illustrating an example of application of the boundary compensation algorithm of FIG. 6 to the overlap area of FIG. 6.

FIG. 9 is a graph exemplarily illustrating a result of the application of the boundary compensation algorithm.

### DETAILED DESCRIPTION OF CERTAIN INVENTIVE EMBODIMENTS

A photolithography process is generally required in forming thin film transistors (TFTs) on a substrate. However, the level of irradiation exposure is not uniform due to the limitations of the equipment used. Variations in the level of exposure cause inconsistencies in different areas of the substrate. This results in operational variances in TFTs, thereby causing a luminance deviation in the corresponding pixels.

In addition, for polysilicon TFTs, characteristics such as the size of crystals of the polysilicon thin film, mobility, and the like can change when crystallizing amorphous silicon to form a polysilicon thin film. This affects the threshold voltage of the TFT and mobility for each pixel, thereby causing a luminance deviation in the pixels.

In order to compensate for such a luminance deviation, the screen of the display device is photographed using a camera and luminance data for each pixel is acquired by analyzing the photograph. Then, each pixel is driven differently based on the luminance data for each pixel. However, as the resolution of display devices increases, the entire screen cannot be photographed at once due to the resolution of the camera. Thus, the screen needs to be photographed multiple times to be analyzed.

The described technology will be described more fully hereinafter with reference to the accompanying drawings, in which exemplary embodiments of the described technology are shown. As those skilled in the art would realize, the described embodiments may be modified in various different ways, all without departing from the spirit or scope of the described technology.

A display device including touch sensors according to an exemplary embodiment will be described in detail with reference to the accompanying drawings. Hereinafter, although a liquid crystal display (LCD) is mainly described, the described technology may also be applied to other display devices such as an organic light-emitting diode (OLED) display and an electrophoretic display (EPD).

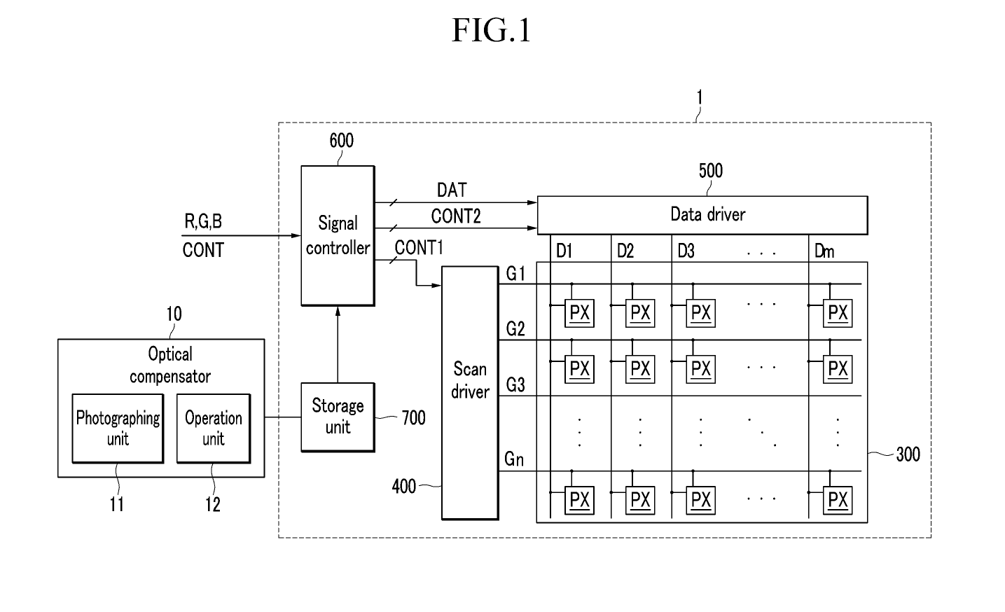

Referring to FIG. 1, a display device 1 includes a display panel 300, a scan driver 400 and a data driver 500 connected to the display panel 300, a signal controller 600 controlling the scan driver 400 and the data driver 500, and a storage unit or memory 700 storing various data related to the operation of the signal controller 600.

The display panel 300 includes a plurality of scanning signal lines or scan lines G1 to Gn, a plurality of data lines D1 to Dm, and a plurality of pixels PX connected to the scanning signal lines and the data lines and arranged in a matrix.

The scan driver 400 is connected to the scanning signal lines G1 to Gn of the display panel 300 and applies scan signals to the scanning signal lines G1 to Gn.

The data driver 500 is connected to the data lines D1 to Dm of the display panel 300 and applies data voltages corresponding to an image signal to the data lines D1 to Dm.

The signal controller 600 controls the scan driver 400 and the data driver 500. The signal controller 600 receives image signals R, G, and B and a control signal CONT from an external source. The control signal may include a horizontal synchronizing signal Hsync, a vertical synchronization signal Vsync, a clock signal CLK, a data enable signal DE, or the like. The signal controller 600 processes the image signals R, G, and B in accordance with an operation condition of the display panel 300 and based on the control signal CONT. The signal controller 600 then generates and outputs image data DAT, a scan control signal CONT1, a data control signal CONT2, and a clock signal.

The signal controller 600 reads data from the storage unit 700 that stores data such as an algorithm for as image process, a lookup table, a compensation parameter, and the like. The storage unit 700 may include a non-volatile memory such as an electrically erasable or programmable ROM (EEPROM).

An optical compensator 10 that may be provided outside of the display device 1 includes a photographing unit or camera 11 photographing a screen of the display panel 300 and an operation unit or optical processor 12 generating luminance data for each pixel from data acquired by the photographing unit 11 and generating a compensation parameter. The photographing unit 11 may include a charge-coupled device (CCD) camera. According some embodiments, the operation unit 12 is provided in the display device 1.

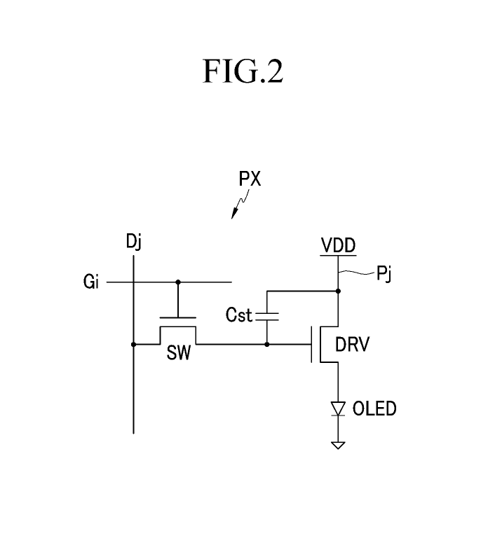

Referring to FIG. 2, a scanning signal line Gi transmitting a scan signal and a data line Dj transmitting a data voltage are connected to each pixel PX. When the display device is embodied as an OLED display, a power line Pj that transmits a driving voltage VDD is also connected to the pixel PX.

The pixel PX includes a switching transistor SW, a driving transistor DRV, a storage capacitor Cst, and an OLED. Although it is not illustrated, each pixel PX may further include a thin film transistor and/or a capacitor to compensate a current supplied to the OLED.

A control terminal of the switching transistor SW is connected to the scanning signal line Gi, an input terminal thereof is connected to the data line Dj, and an output terminal thereof is connected to the driving transistor DRV. The switching transistor SW transmits the data voltage received from the data line Dj to the driving transistor DRV in response to the scan signal received from the scanning signal line Gi.

A control terminal of the driving transistor DRV is connected to the switching transistor SW, an input terminal thereof is connected to the power line Pj, and an output terminal thereof is connected to the OLED. The amount of current flowing through the driving transistor DRV is controlled according to the voltage between the control terminal and the output terminal of the driving transistor DRV.

The storage capacitor Cst is connected between the control terminal and the input terminal of the driving transistor DRV. The storage capacitor Cst stores a data voltage applied to the control terminal of the driving transistor DRV and maintains the data voltage even after the switching transistor SW is turned off such that the OLED can continuously emit light until the application of the next data voltage.

The OLED includes an anode connected to the output terminal of the driving transistor DRV and a cathode connected to a ground voltage or a common voltage. The OLED emits light with an intensity based on the output current of the driving transistor DRV to display an image.

Since the OLED is a current driving element, TFT characteristics such as a threshold voltage, mobility, and the like need to be uniform among the driving transistors DRV of the display. However, the TFT characteristics cannot be uniform due to current technical limits in the production of OLED displays. Thus, a deviation from the ideal luminance can occur for each pixel according to the characteristic deviation of the corresponding TFT. That is, each pixel may have a different luminance even through the same gray voltage is applied to all pixels. Such a luminance deviation in each pixel may occur not only in OLED displays but also in other display devices TFTs.

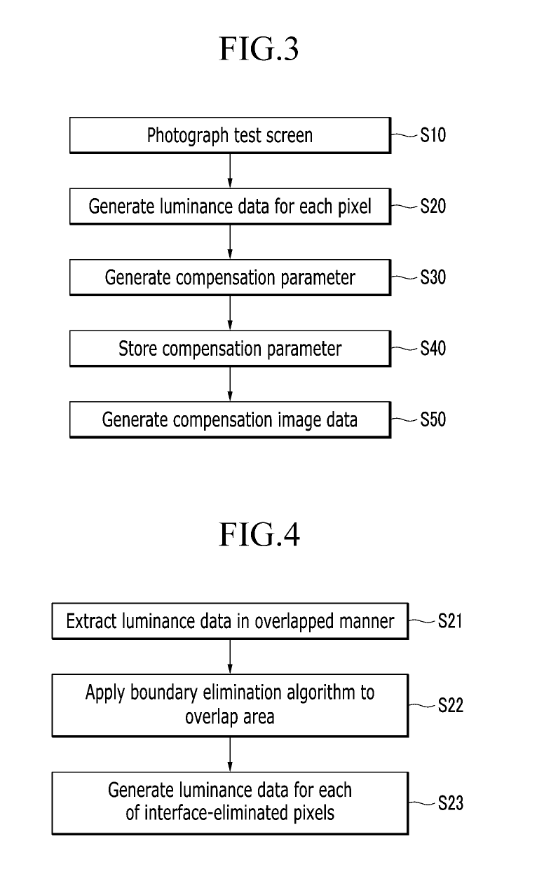

FIG. 3 is a flowchart provided for the description of a schematic process of an optical compensation method of the display device according to an exemplary embodiment. In some embodiments, the method of FIG. 3 is implemented in a conventional programming language, such as C or C++ or another suitable programming language. The program can be stored on a computer accessible storage medium of the display device 1, for example, the storage unit 700. In other embodiments, the program is stored on a memory of the optical compensator 10. In certain embodiments, the storage medium includes a random access memory (RAM), hard disks, floppy disks, digital video devices, compact discs, video discs, and/or other optical storage mediums, etc. The program may be stored in a processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor can execute applications with the assistance of operating systems such as Unix, Linux, Microsoft DOS, Microsoft Windows 7/Vista/2000/9x/ME/XP, Macintosh OS, OS/2, Android, iOS and the like. In another embodiment, at least part of the procedure can be implemented with embedded software. Depending on the embodiment, additional states may be added, others removed, or the order of the states changed in FIG. 3. The description of this paragraph also applies to the procedure of FIG. 4.

For compensation of the display device, the photographing unit 11 of the optical compensator 10 photographs a test image displayed in the display device (S10). The photographing unit 11 may use a CCD camera. The photographing may be performed on each of the R, G, and B images of a specific gray level. For example, when the display panel is formed of an R pixel, a G pixel, and a B pixel, the photographing unit 11 may respectively photograph a red image when driving only the R pixels, a green image when driving only the G pixels, and a blue image when driving only the B pixels. Such a photographing process may be performed a number of times for different gray levels, or may be performed by driving pixels having different colors by combining the pixels.

Depending on the resolution of the display device, the photographing may be performed with respect to the entire test image or may be performed on each of a plurality of areas divided from the test image. For example, for a Quad HD (QHD) display device having high resolution of over 2560×1440, luminance data for the entire screen cannot be acquired from one photograph due to a limit in resolution of the CCD camera. Thus, for example, the screen is divided into left and right areas and the left-side area and the right-side area may be respectively photographed using the CCD camera.

The number of divisions of the screen depends on the resolution of the display device and the resolution of the camera. That is, as the resolution of the display device increases and as the resolution of the camera decreases, the number of divisions of the screen may increase. For example, the screen may be divided into left, middle, and right areas or up, down, left, and right areas. However, this is not restrictive. The size of areas divided from a screen may be equivalent to each other or may be different from each other.

Photographing of each of the divided areas may include not only the corresponding divided area but also a part of an adjacent divided area including a boundary with the adjacent divided area. Accordingly, photographing of the periphery area of the boundary of the divided areas is overlapped with an adjacent divided area.

Next, the operation unit 12 generates luminance data for each pixel from the photographed data (S20). The luminance data may include information such as color temperature, color coordinates, and the like. The luminance data may be extracted from the photographed data and the detailed process is known to a person skilled in the art.

Then, the operation unit 12 generates a compensation parameter with respect to each pixel from the generated luminance data (S30). In this step, information related to a threshold voltage (and optionally electron mobility) of a TFT that may cause a luminance deviation of each pixel may be calculated with respect to all pixels from the luminance data and a parameter for compensation of a difference from a reference luminance may be generated using the calculated data. The reference luminance may be a predetermined target value.

When the compensation parameter is generated, the storage unit 700 stores the compensation parameter (S40). The compensation parameter may be stored in a temporary memory of the optical compensator 10 before being stored in the storage unit 700 of the display device.

When the image signals R, G, and B are input, compensation is performed using the compensation parameter to generate luminance-compensated image data DAT (S50). Accordingly, a luminance deviation of each pixel can be improved. The step S50 may be performed by a luminance compensator including a compensation circuit in the signal controller 600. According to some embodiments, the luminance compensator may be separately provided at a front end of the signal controller 600. Compensation of the image data may include conversion of a gray value with respect to each pixel. A process for compensation of image data using a parameter is known to a person skilled in the art.

Hereinafter, the step S20 of FIG. 3 for a screen that is divided and photographed a number of times to acquire luminance data from a test image will be described in detail.

As described above, when the display device has a high-resolution, the screen can be divided into left and right areas and the photographing of a boundary portion between the two divided areas is duplicated. When luminance data for each pixel is generated for the entire screen by respectively extracting luminance data from the left-side area and the right-side area from the data acquired from two photographing steps, a deviation in the extracted luminance data may occur around a boundary line of the left and right side areas. If an input image signal is compensated based on luminance data including such a deviation, the input signal is compensated by a luminance deviation that is not attributable to the display device 1. Accordingly a luminance deviation is generated in the compensated image.

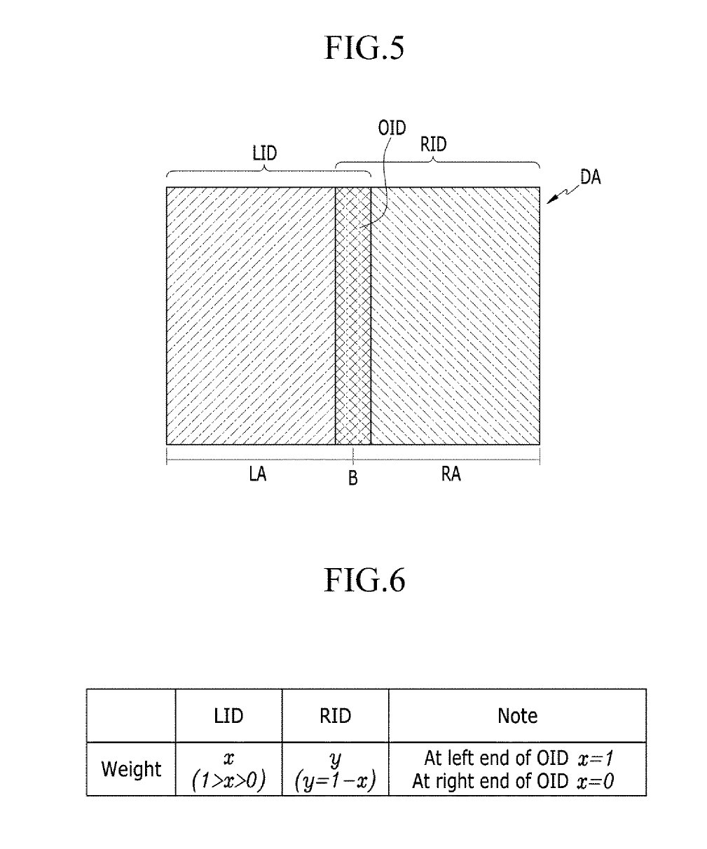

Referring to FIG. 5, a display area DA of the display device is divided into a left-side area LA and a right-side area RL with reference to a boundary line B. In the embodiment of FIG. 5, luminance data with respect to the entire screen can be simply acquired by extracting luminance data for the left-side area LA and luminance data for the right-side area RA from the data of the two photographing steps. However, when the luminance data is acquired in such a manner, the luminance data of the left-side area LA and the luminance data of the right-side data RA are not continuous, which can generate a deviation in luminance at both sides of the boundary line B. Such a deviation may be caused by distortion, vignetting, or the like at corners due to CCD noise of the camera and the curvature of an imaging pickup lens.

According to some embodiments, when luminance data for each pixel of the entire screen is generated from two sets of photographed data, luminance data is extracted such that the left-side area and the right-side area are partially overlapped at the boundary therebetween (S21). The degree of overlapping may be changed according to the resolution of the display, resolution of the camera, and the like. However, as the degree of overlapping increases, the difficulty in extracting luminance data increases.

Referring back to FIG. 5, left-side luminance data LID and right-side luminance data RID are extracted to overlap in the periphery area of the boundary line B. For example, when the resolution of the display device is QHD (2560×1440), the left-side luminance data LID may be luminance data of pixels from a first pixel array to a 1370^{th} pixel array and the right-side luminance data RID may be luminance data of pixels from an 1190 pixel array to a 2560^{th} pixel array. In this case, overlap luminance data OID from the 1190 pixel array to the 1370^{th} pixel array (a total of 180 pixel arrays) are overlapped. In the present specification, luminance data extracted to overlap is called overlap luminance data and the area corresponding to the overlap luminance data is called an overlap area.

In processing of the overlap luminance data OID, a boundary elimination algorithm is applied (S22). Here, the boundary elimination algorithm, for example, subdivides the overlap luminance data OID with respect to a plurality of pixel array groups and adds luminance data of the respective pixel array groups by applying a different weight to left-side luminance data LID and right-side luminance data RID.

Referring to FIG. 6, a weight of 1 is applied to left-side luminance data LID and a weight of 0 is applied to right-side luminance data RID at the left end of the overlap luminance data OID. A weight of 1 is applied to right-side luminance data RID and a weight of 0 is applied to left-side luminance data LID at the right end of the overlap luminance data OID. Between the left end and the right end of the overlap luminance data OID, the weight of the left-side luminance data LID gradually decreases toward the right end from the left end and the weight of the right-side luminance data RID increases proportionally to the decrease of the weight of the left-side luminance data LID.

When weights are respectively applied to left-side luminance data LID and right-side luminance data RID in the above-stated manner, the sum of the weight of the left-side luminance data LID and the weight of the right-side luminance data RID is 1 for any given point in the overlap area. Thus, when a weight is applied to each of left-side luminance data LID and right-side luminance data RID in overlap luminance data OID where the left-side luminance data LID and the right-side luminance data RID are overlapped and then the weights are added, luminance data having no overlapping data is acquired. Hereinafter, the luminance data is called compensation luminance data. Since weights are applied in a manner that the left-side luminance data LID is gradually decreased and the right-side luminance data RID is gradually increased, left-side luminance data LID is more reflected in the left end side of the overlap luminance data OLD and right-side luminance data RID is more reflected in the right end side of the overlap luminance data OID. Thus, a boundary between the left-side luminance data and the right-side luminance data is eliminated and the entire luminance data can be almost continuous with natural luminance change like photographing a screen using one camera.

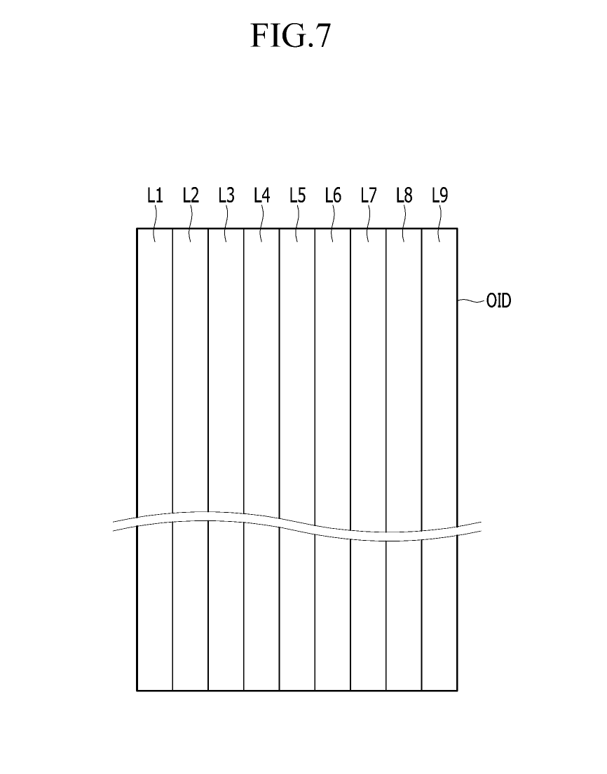

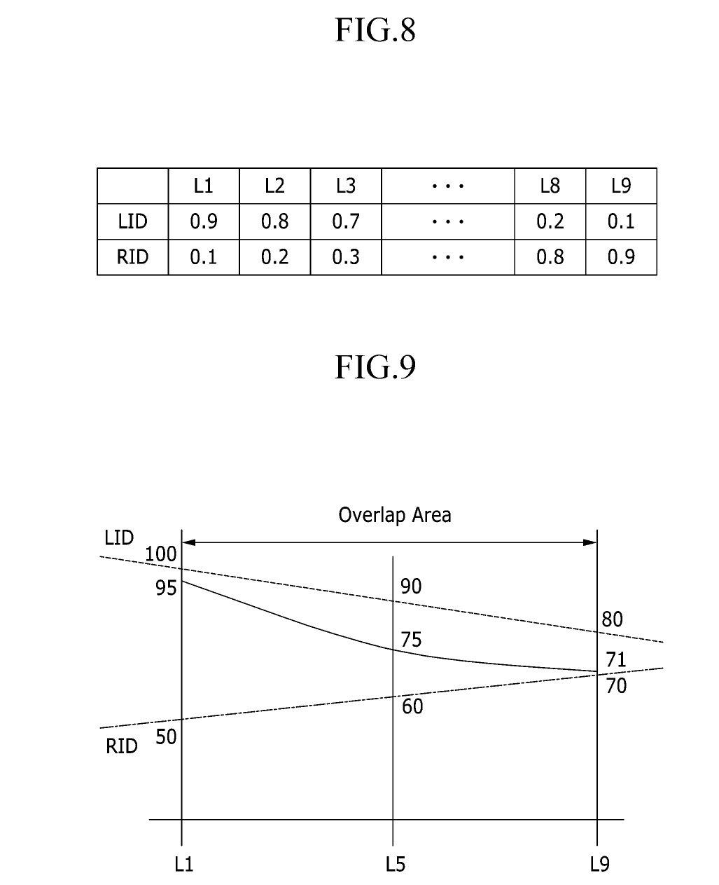

According to some embodiments, the overlap luminance data OID can be sub-divided into nine pixel array groups as shown in FIG. 7 and FIG. 8, which will be described in further detail. In the above-stated QHD display device, when pixel arrays corresponding to overlap luminance data OID extend from the 1191^{st} pixel array to the 1370^{th} pixel array and the pixel arrays are sub-divided into nine pixel arrays, the pixel arrays may be divided into the 1191^{st} to the 1210^{th} pixel array L1, the 1211^{th} pixel array to the 1230^{th} pixel array L2, the 1231^{st} pixel array to the 1250^{th} pixel array L3, the 1251^{st} pixel array to the 1270^{th} pixel array L4, the 1271^{st} pixel array to the 1290^{th} pixel array L5, the 1291^{st} pixel array to the 1310^{th} pixel array L6, the 1311^{th} pixel array to the 1330^{th} pixel array L7, the 1331^{st} pixel array to the 1350^{th} pixel array L8, and the 1351^{st} pixel array to the 1370^{th} pixel array L9. In this embodiment, each of the pixel array groups L1 to L9 includes 10 pixel arrays.

When the overlap luminance data OID is sub-divided into nine pixel array groups L1 to L9, 9 steps in the weights may be set to respectively correspond to the nine pixel array groups. That is, as shown in FIG. 8, a weight of 0.9 is applied to the first pixel array group in the left-side luminance data LID and the weight gradually decreases by 0.1 toward the right-side pixel array group so as to apply a weight of 0.1 to the ninth pixel array group. Conversely, a weight of 0.1 is applied to the first pixel array group in the right-side luminance data RID and the weight gradually increases by 0.1 toward the right-side pixel array group so as to apply a weight of 0.9 to the ninth pixel array group. Thus, the sum of weights in the respective pixel array groups is 1. However, the increase or decrease of the weights may not necessarily be linear, and the weights may be non-linearly increased or decreased.

Referring to FIG. 9, for simplification of description, it is assumed that left-side luminance data LID is linearly decreased from 100 to 80 and the right-side luminance data RID is linearly increased from 50 to 70 in the overlap area. A weight of 0.9 is multiplied by the left-side luminance data value of 100 and a weight of 0.1 is multiplied by the right-side luminance data value of 60 and the weighted values are summed together such that a compensated luminance data of 95 is acquired in the first pixel array group L1. In this manner, weights applied to left-side luminance data and right-side luminance data are multiplied and then added in the respective pixel array groups. Then, compensation luminance data value indicated by a solid line is acquired between the line indicating the left-side luminance data value and the line indicating the right-side luminance data value as shown in FIG. 9. For example, compensation luminance data value of 75 is acquired in the fifth pixel array group L5 and compensation luminance data value of 71 is acquired in the ninth pixel array group L9.

In the overlap area, the compensation luminance data values are continuously changed. The compensation luminance data has a difference of 5 with the left-side luminance data at the left end side and has a difference of 1 with the right-side luminance data at the right end side in the overlap area. The difference at the right end side is relatively smaller than the difference at the left end side. On the other hand, when luminance data is extracted with respect to each of the left-side area and the right-side area without overlapping of luminance data, a luminance data deviation between left and right sides with reference to a boundary of the left-side area and the right-side area becomes significant. For example, when L5 is a boundary between the left-side area and the right-side area in the graph of FIG. 9, the left-side data and the right-side data differ by about 30 rather than being continuous.

When compensation luminance data for the overlap area is calculated by applying the boundary elimination algorithm, luminance data for each pixel of which a boundary is eliminated throughout the entire screen is generated (S23).

According to at least one embodiment, the display area is divided into left and right areas and luminance data is generated for each pixel of the entire screen. However, the display area may be divided into up and down areas and then luminance data of each pixel of the entire screen may be generated using the same process described above. However, in this embodiment, overlap luminance data should be sub-divided with reference to a pixel row instead of a pixel column in processing of the overlap luminance data.

While the described technology has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An optical compensation method for a display device comprising a display panel including a plurality of pixels, the method comprising:
displaying a test image on the display panel, wherein the display panel comprises first, second, and third areas;
photographing the first and second areas together to generate first photographed data;
photographing the second and third areas together to generate second photographed data;
extracting luminance data from each of the first and second photographed data;
respectively applying different weights to the luminance data of the second area extracted from each of the first and second photographed data to generate compensated luminance data;
generating pixel luminance data for each pixel from the luminance data of the first area, the compensated luminance data of the second area, and the luminance data of the third area;
generating a compensation parameter for each pixel based at least in part on the pixel luminance data;
storing the compensation parameter for each pixel; and
compensating a luminance for each pixel based at least in part on the compensation parameter of the corresponding pixel.

2. The optical compensation method of claim 1, wherein the applying includes applying a first weight to the luminance data extracted from the first photographed data and a second weight to the luminance data extracted from the second photographed data, wherein the first weight gradually decreases from the first area to the third area and wherein the second weight gradually increases from the first area to the third area.

3. The optical compensation method of claim 2, wherein the first weight is less than 1 and greater than 0 and wherein the sum of the first weight and the second weight is 1.

4. The optical compensation method of claim 3, wherein the applying comprises:
dividing the second area into a plurality of sub-areas, wherein each of the first and second weights has a different value in each of the sub-areas; and
summing the weighted luminance data.

5. The optical compensation method of claim 4, wherein the dividing includes dividing the second area into first to ninth sub-areas and wherein the first weight is 0.9 in the first sub-area and decreases by 0.1 for each sub-area toward the ninth sub-area.

6. The optical compensation method of claim 1, wherein the second area comprises about 100 to about 300 pixel arrays.

7. The optical compensation method of claim 1, wherein the generating of the compensation parameter comprises i) calculating data related to a thin film transistor (TFT) threshold voltage based at least in part on the pixel luminance data and ii) generating the compensation parameter for each pixel based at least in part on the calculated data.

8. The optical compensation method of claim 1, wherein the storing comprises storing the compensation parameter for each pixel in a non-volatile memory.

9. The optical compensation method of claim 1, wherein the compensating comprises compensating an input image signal to generate luminance-compensated image data.

10. A display device, comprising:
a display panel including a plurality of pixels and configured to display a test image, wherein the display panel comprises first, second, and third areas;
a signal controller configured to i) generate image data based at least in part on a received image signal and ii) generate a signal configured to control operation of the display panel;
a memory storing a compensation parameter for each pixel; and
an optical processor configured to:
receive first and second photographed data, wherein the first photographed data includes luminance data corresponding to the first and second areas and wherein the second photographed data includes luminance data corresponding to the second and third areas;
extract luminance data from each of the first and second photographed data;
respectively apply different weights to the luminance data of the second area extracted from each of the first and second photographed data to generate compensated luminance data; and
generate the compensation parameter for each pixel based at least in part on the luminance data and the compensated luminance data.

11. The display device of claim 10, wherein the optical processor is further configured to apply a first weight to the luminance data extracted from the first photographed data and a second weight to the luminance data extracted from the second photographed data, wherein the first weight gradually decreases from the first area to the third area and wherein the second weight gradually increases from the first area to the third area.

12. The display device of claim 11, wherein the first weight is less than 1 and greater than 0 and wherein the sum of the first weight and the second weight is 1.

13. The display device of claim 12, wherein the optical processor is further configured to:
divide the second area into a plurality of sub-areas, wherein each of the first and second weights has a different value in each of the sub-areas; and

14. [symbol] sum the weighted luminance data. The display device of claim 13, wherein the optical processor is further configured to divide the second area into first to ninth sub-areas and wherein the first weight is 0.9 in the first sub-area and decreases by 0.1 for each sub-area toward the ninth sub-area.

15. The display device of claim 10, wherein the second area comprises about 100 to about 300 pixel arrays.

16. The display device of claim 10, wherein the generating of the compensation parameter comprises i) calculating data related to a thin film transistor (TFT) threshold voltage based at least in part on the pixel luminance data and ii) generating the compensation parameter for each pixel based at least in part on the calculated data.

17. An optical compensator for a display device comprising a display panel including first, second, and third areas, where the first and second areas have been photographed together as first photographed data and the second and third areas have been photographed together as second photographed data, and a plurality of pixels, the optical compensator comprising:
an optical processor configured to:
extract luminance data from each of the first and second photographed data;
apply a boundary elimination algorithm to the luminance data of the second area extracted from each of the first and second photographed data to generate compensated luminance data; and
generate a compensation parameter for each pixel of the display device based at least in part on the luminance data and the compensated luminance data.

18. The optical compensator of claim 17, wherein the optical processor is further configured to respectively apply different weights to the luminance data of the second area extracted from each of the first and second photographed data to generate the compensated luminance data.

19. The optical compensator of claim 17, further comprising a memory configured to store the compensation parameter for each pixel.

20. The optical compensator of claim 17, wherein the optical processor is further configured to divide the second area into a plurality of sub-areas and apply a different weight to the luminance data of each sub-area extracted from the first and second photographed data to generate the compensated luminance data.
